(19) United States
(12) Patent Application Publication
(10) Pub. No.: US 2006/0245561 A1
(43) Pub. Date: Nov. 2, 2006

(54) Method of advertising using a telephone system

(76) Inventor: Jeffrey Conforti, Franklin Lakes, NJ (US)

Correspondence Address: RALPH T. LILORE;ATTORNEY AT LAW, THIRD FLOOR, 371 FRANKLIN AVENUE, NUTLEY, NJ, 07110, US

(21) Appl. No.: 11/409,142

(22) Filed: Apr. 21, 2006

Related U.S. Application Data
(60) Provisional application No. 60/676,591, filed on Apr. 29, 2005.

(51) Int. Cl. H04M 11/00

(52) U.S. Cl. 379/93.12

(57) ABSTRACT

A method of advertising utilizing a break, interval or hiatus in a telephone system connection with a caller or recipient, wherein during said break, an advertising message is delivered to the caller or recipient of a call.

### RELATIONSHIP TO PRIOR APPLICATION

This Application claims the priority of U.S. Provisional Application Ser. No. 60/676,591 filed Apr. 29, 2005.

### BACKGROUND OF THE INVENTION

### Field of the Invention

This invention relates to the use of the telephone to send advertising messages. More particularly, the invention relates to the use of dead time in a telephone line connection to transmit advertising messages to a party.

During the use of a telephone system, there are many intervals of silence occasioned by a pause while a party or caller is connected to the telephone, or by being placed on hold or the like. This invention relates to the use of those dead times as the space within which advertising messages can be sent to the users of the phone, either the caller or the recipient or both.

The advertising message is usually a short one in these cases, tailored to the expected delay on hold. Of necessity, the expected hold time for most transfers and other usages will be short but this provides an opportunity for utilization of that dead time in a very useful and rewarding way.

### BRIEF SUMMARY OF THE INVENTION

The following terms used herein include the following meanings:

Host System—includes the telephone system in which the advertising message is initiated. Examples of host systems include: the switching station of the first or any subsequent telephone company reached by the caller's act of dialing, any recipient of the caller's call, individuals, companies, departments and the like.

Caller—includes an entity who calls the host system.

Host Caller—includes a caller who calls from the host system to third party.

Recipient—includes a person who receives a call from the caller or the host caller, as the case may be.

During the use of the telephone there are often short periods of time during which there is a dead time i.e. no conversation occurring between parties. This can happen at virtually any stage of a telephone call starting with initiation of the call to termination of the call. For example, the normal telephone call starts with a caller dialing the desired number and reaches a host system represented in the first instance by a telephone company in the area. Before the actual switching to the dialed number begins, a finite, albeit, short interval of dead time is experienced before the so-called “ringing” occurs at the recipient's location. This dead time, according to the invention, can be used as an interval of advertising by the telephone company. Other opportunities are presented frequently when callers are put on hold or one party has to be transferred to another, or some information is being sought by a particular party and the other party, instead of disconnecting the call, again puts the party on hold. Thus, the invention utilizes any silent hiatus in the continuum of a telephone connection, which can be filled with advertising and advertising messages. It is during such intervals that there is an opportunity to provide information of various kinds to either the caller or the recipient.

### DETAIL DESCRIPTION OF THE INVENTION

Currently, one often hears music filling in these voids, or perhaps a connection to a radio station or simply silence until a connection is made. Often one hears a reassuring waiting message, such as “Your call is important to us, please remain on the line and the next available representative will assist you” followed by silence and then perhaps repetitions of the message as time goes on.

Sometimes other information is presented. For example, airlines often utilize the dead space as a time to present flight schedules or other information for the airline. These messages and others like them are generally informative, and have the effect of assuaging the callers so that they do not get bored and hang up. The messages are not advertising and it is believed that the present invention is the first time that an advertising message use has been disclosed.

In a typical telephone call to a large commercial establishment, a caller may be greeted by the recipient or a recorded message or may even be greeted by silence until the “ringing sounds” begin. Following this time, or after the caller identifies the party sought, the operator then disconnects the caller from the switchboard, creating a hiatus until the connection to the sought party is made. According to the invention, the system may automatically engage an advertising message which will play during the hiatus. For example, a short hiatus advertising message might be: “Drink XYZ Cola for extra-added pleasure”.

The foregoing is obviously an example of only one kind of message that may be presented. Various other messages of every kind and stripe may be used, if they are tailored appropriately to the length of the hiatus.

Thus, the present invention provides frank, unmistakable advertising to a caller who is awaiting a connection to a host system or recipient. The following scenario is representative:
Caller dials a telephone number (Host System).
The call is connected to the telephone company switching system (part of the Host System). After a brief interval (hiatus) ringing begins at the ultimately desired host system creating a hiatus during the ringing. The “ringing” is answered at the host system by a person or a recorded voice or message.
Caller requests a certain number or party. The host system puts the caller on hold while the system or the recipient searches for the party. The interval on hold is a hiatus. Each hiatus in the phone scenario may be filled in with an advertising message until the hiatus is interrupted by the sought party or some other intervening entity.

The reverse of the foregoing:
A host caller from the host system calls a recipient telephone. The call is connected following a brief hiatus at the switching station (also a host system) and ringing of the recipient. Then, the recipient telephone is answered.
Host caller requests a certain number or party at recipient number. Host caller has occasion to create a hiatus in the call to recipient. The advertising message fills in the hiatus.

With the foregoing in mind, the method of the invention can be stated as follows:

A method of advertising using a telephone system comprising:
a. obtaining at least one telephone caller to, or a recipient of a telephone call from, a given host telephone system,
b. effecting the telephonic connection from the caller or recipient to the host telephone system whereby the caller or recipient is connected to the host telephone system,
c. obtaining an advertisement to be transmitted audibly, visually or both, to said caller or recipient,
d. effecting a hiatus (at least one) in the telephone call during which a caller or recipient remains connected to the telephone system, and
e. transmitting said advertisement in audible, visual (or both) form to said caller or recipient through said host telephone system during said hiatus.

The telephone system can be any type of system, such as a landline, or a microwave or satellite cellular telephone system, or the like. Such telephone systems are available in formats which can receive the message in video (visual) or audio format or both.

In the method, the host telephone system is put into service either by a caller calling into the system or by a host caller calling out from the system, and the call is completed between the parties, i.e. by completing the connection between the caller or recipient and the Host Telephone System.

The advertisement can be any kind, but of course, will be an audible one unless the telephone has a video or camera type capability, in which case, it might be visual as well. It most likely will be taped or recorded but there is nothing to prevent it from being “in person” and in real time. A configuration of the telephone system may be employed such that when the call is placed on “hold” that act alone activates the transmittal of the advertisement. If it were a closed loop, a message could be played over and over again.

As different types of advertisements, there may be mentioned visual, audible, musical, singing type (jingles), spoken words, and combinations of these. The advertisement may take up the whole time of the hiatus or any part thereof.

The technology for performing the method of the invention is well-known to those skilled in the art. No additional technology is needed, it being well understood that current software switching mechanisms and circuitry are adequate to provide the advertising message in activated form when the appropriate disconnect and switches are themselves activated.

The method of the invention can be employed any time a telephone system is put into use by either a call in or a call out, provided the system is equipped with an advertisement, which can be transmitted to the caller or the recipient as the case may be.

What is claimed is:

1. A method of advertising using a telephone system comprising:
a. obtaining at least one telephone caller to, or a recipient of a given host telephone system whereby the telephonic connection from the caller or recipient to the host telephone system is effected and said caller or recipient is connected to the host telephone system,
b. obtaining an advertisement to be transmitted audibly or visually or both, to said caller or recipient through the telephone system,
c. effecting at least one hiatus in the telephone call during which a caller or recipient remains connected to the telephone system, and
d. transmitting said advertisement audibly, visually or both, to said caller or recipient through said host telephone system during any such hiatus.

2. The method of claim 1 wherein said host telephone system is the local FCC licensed telephone company.

3. The method of claim 1 wherein said host telephone system is the entity ultimately desired by the caller.

4. The method of claim 2 wherein the hiatus is created in the host telephone system prior to the time the telephone call is transmitted by the host telephone system to the recipient and is received by the recipient.
